(19) United States
(12) Patent Application Publication
(10) Pub. No.: US 2001/0041981 A1
(43) Pub. Date: Nov. 15, 2001

(54) Partial redundancy encoding of speech

(76) Inventors: Erik Ekudden, Akersberga (SE); Johan Sjoberg, Stockholm (SE)

Correspondence Address: JENKENS & GILCHRIST, PC, 1445 ROSS AVENUE, SUITE 3200, DALLAS, TX, 75202, US

(21) Appl. No.: 09/789,691

(22) Filed: Feb. 20, 2001

Related U.S. Application Data
(60) Provisional application No. 60/183,846, filed on Feb. 22, 2000.

(51) Int. Cl. G10L 21/00

(52) U.S. Cl. 704/270.1

(57) ABSTRACT

A method and apparatus for partial redundancy encoding of a speech data packet. The bits in the speech data packet are sorted according to a predetermined error sensitivity characteristic, order, level or degree of importance. Only those bits in the packet which are considered to be most error sensitive are protected by redundant transmission. A partial set of redundant bits of the previously transmitted packets are included with the data bit for current packet. The redundant bits are used at the receiver side to reconstruct damaged packets. By using only the most sensitive bits for redundancy, the additional required and width may be limited.

### BACKGROUND OF THE PRESENT INVENTION

1. Field of the Invention

The invention relates generally to protection of encoded speech data and, more particularly, to protection of such speech data by encoding partial redundancy.

2. Description of the Related Art

The tremendous success of the Internet has made it desirable to expand the Internet Protocol (IP) to a wide variety of applications including voice and speech communication. The objective is, of course, to use the IP links, such as the Internet, for transporting voice and speech data. Speech data is presently transported over the links using IP-based transport layer protocols such as the User Datagram Protocol (UDP) and the Real-time Transport Protocol (RTP). In a typical application, a computer running telephony software converts speech into digital data which is then assembled into IP-based data packets suitable for transport over the Internet. Additional information regarding the UDP and RTP transport layer protocols may be found in the following publications which are incorporated herein by reference: Jon Postel, User Datagram Protocol,DARPA RFC 786, August 1980; Henning Schulzrinne et al., RRT: A Transport Protocol for Real-time Applications, IETF RFC 1889, IETF Audio/video Transport Working Group, January 1996.

A typical speech data packet 10 conforming to the IP-based transport layer protocols such as UDP and RTP is shown in FIG. 1. The packet 10 is one packet in a plurality of related packets that form a stream of packets representing speech data being transferred over a packet-switched communication network such as the Internet. In general, the packet 10 is made of a transport layer header 12 and a payload 14. The transport layer header 12 contains various information about the packet 10 including the IP version number, source and destination addresses, times stamps, etc. The payload 14 is made of a payload header portion 16 and a data portion 18. The payload header portion 16 contains various information about the payload 14 including the format etc. The data portion 18 contains control data and speech data associated with one or more speech frames which have been encoded or otherwise compressed by a speech codec.

FIG. 2 illustrates a pertinent portion of an exemplary packet-switched communication network 20. A packet source 22 such as the Internet provides a media stream of data packets 10 across a link 24 to an access technology 26 such as, for example, a base station, or a variety of other access technology as is understood in the art. The access technology 26 processes the data packets 10 for transmission over a link 28 to a receiver 30 such as, for example, a mobile unit. The link 28 may be any radio interface between the access technology 26 and the receiver 30 such as, for example, a cellular link. The receiver 30 receives the data packets from the access technology 26 and forwards them to their intended application, for example, a speech codec (not shown).

However, due to the lossy nature of the network 20 in general and of the radio interfaces 28 in particular, a high packet loss ratio may be observed over the network 20. As a result, the quality of the transported speech may be degraded to below certain predefined acceptance levels. The strict delay requirements of real-time media stream transmission limits the retransmission of lost packets. The problem is exacerbated if several consecutive packets in the stream are lost. Therefore, in order to improve the robustness of the packets transferred over such networks, a number of packet error correction algorithms have been proposed.

One such algorithm calls for streams of fully redundant data to be sent in parallel with the original stream. Any lost packets may then be replaced with the packets in the redundant streams. Additional information on this algorithm can be found in IETF RFC 2198, RTP Payload for Redundant Audio Data. However, handling of the so-called parallel redundant streams may add complexity to both the encoder and decoder. Moreover, if the redundant streams are encoded with encoding algorithms that are different from the original stream, the data may suffer from artifacts as a result of combining partly corrupted data from different coding algorithms.

Another error correction algorithm, called Forward Error Correction (FEC), involves selecting a set of packets from the media stream and applying an XOR operation on those packets across the payloads. The result is an FEC packet containing the XOR information. The FEC packet may then be used to recover any of the selected packets which might be lost. More information on the FEC algorithm may be found in IETF RFC 2733, An RTP Payload Format for Generic Forward Error Correction. However, this algorithm may consume significant additional bandwidth because FEC protection is typically provided to all bits in a selected packet and causes a significant additional delay to recover the lost payloads. Therefore, it is desirable to be able to provide robustness over packet-switched networks with little or no additional complexity and bandwidth.

The present invention provides robustness over packet-switched networks with little or no additional complexity or bandwidth. In particular, the present invention allows any additional bandwidth required to be tailored to the specific sensitivity of the encoded media stream, thereby providing a more efficient transmission scheme.

### SUMMARY OF THE INVENTION

The present invention is directed to a method and apparatus for partial redundancy encoding of a speech data packet. The bits in the speech data packet are sorted in a predefined order of importance corresponding to the error sensitivity characteristics of the encoded media stream. Only those bits in the packet which are considered to be most error sensitive are protected by redundant transmission. A partial set of redundant bits of the previously transmitted packets are included with the data bit for current packet. The redundant bits are used at the receiver side to reconstruct damaged packets. By using only the most important bits for redundancy, the additional required bandwidth may be limited.

In one aspect, the invention is related to a method of transmitting encoded speech data in a packet-switch network. The method comprises sorting the encoded speech data according to a predetermined error sensitivity characteristic, order, level or degree of importance, generating partial redundant data for the sorted encoded speech data, and transmitting a data packet containing the sorted encoded speech data and the partial redundant data.

In another aspect, the invention is related to a system for communicating encoded speech data in a packet-switch network. The system comprises a codec for sorting the encoded speech data according to the predetermined error sensitivity characteristic, order, level or degree of importance, a partial redundancy generator for generating partial redundant data for the sorted encoded speech data, and a transmitter for transmitting a data packet containing the sorted encoded speech data and the partial redundant data.

A more complete appreciation of the present invention and the scope thereof can be obtained from the accompanying drawings (which are briefly summarized below), the following detailed description of the presently-preferred embodiments of the invention, and the appended claims.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates a typical speech data packet;

FIG. 2 illustrates a packet-switched communication environment;

FIG. 3 illustrates a format for a payload header;

FIG. 4 illustrates a format for a payload frame;

FIGS. 5 illustrates an exemplary payload including header and frame;

FIG. 6 illustrates a functional block diagram of a transmitter according to an exemplary embodiment of the invention;

FIGS. 7A-7C illustrate sensitivity charts for full and partial frames of speech data, respectively;

FIG. 8 illustrates a sensitivity chart for a frame having full and partial frames of speech data;

FIG. 9 illustrates a functional block diagram of a receiver according to the exemplary embodiment of FIG. 6; and

FIG. 10 illustrates a frame forming process according to the exemplary embodiment of FIG. 9.

### DETAILED DESCRIPTION OF THE PRESENTLY-PREFERRED EXEMPLARY EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

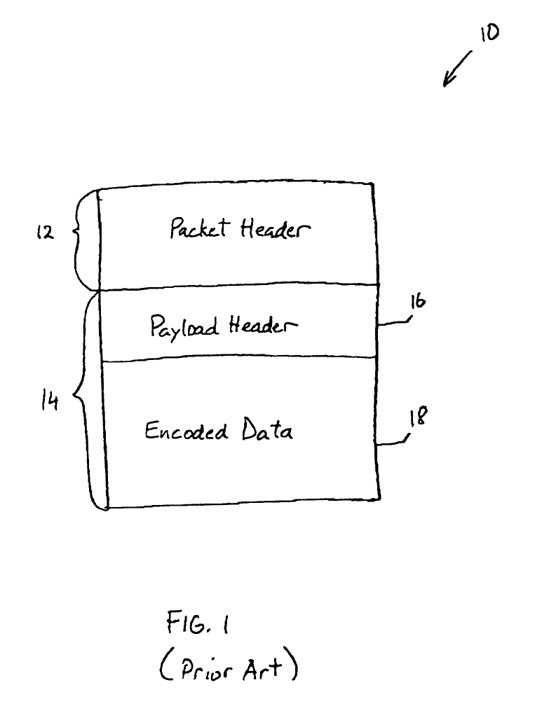

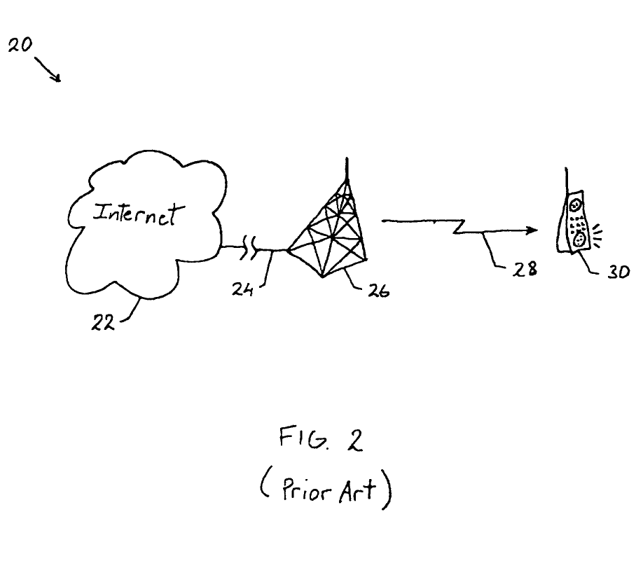

As mentioned previously, a speech data packet 10 conforming to the IP-based transport layer protocols such as UDP and RTP has a header 12 and a payload 14 (see FIG. 1). Within the payload 14 is a payload header 16 and an encoded data 18. The present invention is able to provide robustness over the packet-switched networks while incurring little or no additional complexity or bandwidth by transmitting only a partial redundancy, i.e., a redundancy only for the more error sensitive bits in the speech frames of the encoded data 18. In other words, the bits for which redundancy is transmitted are preferably those bits which have been tested and deemed to be necessary for achieving a certain predefined characteristics of speech quality. Alternatively, the error sensitivity testing may be performed on a group or block of bits.

The test for error sensitivity may be a perceptual test based on an objective standard such as a predefined level of acceptance, or a subjective standard based on surveys of a subset of the general population. An example of the error sensitivity sorting process can be found in the European Telecommunications Standards Institute (ETSI) specification 3G TS 26.101, AMR Speech Codec Frame Structure, and will not be described herein. AMR (Adaptive Multi-Rate) speech codec is developed to preserve high speech quality under a wide range of transmission conditions. Due to the flexibility and robustness of AMR, it is suitable for use in various applications. An example would be its use in the real-time services over packet switched networks, e.g. over RTP. To be optimized for transmission over networks with high packet loss rates, the possibility to use extra redundancy is built into the RTP payload format for AMR.

Referring now to FIG. 3, the present invention uses a payload header 30. For reference, the numbers across the top of the payload header 30 represent bit positions. The payload header 30 has a dynamic length, either 3 or 8 bits, with the bits specified as follows:

Q (1 bit): Indicates whether the payload has been severely damaged. If Q=1, then there has been little or no damage to the payload.

L (1 bit): Indicates the existence of the length field (LEN) in the frames of data in the payload. This bit can be set only if the receiver has signaled support for the option to transmit redundant data.

R (1 bit): Indicates if the Codec Mode Request (CMR) is sent or not.

CMR (5 bits): This is an optional field and will depend on whether the R bit above is set (R=1).

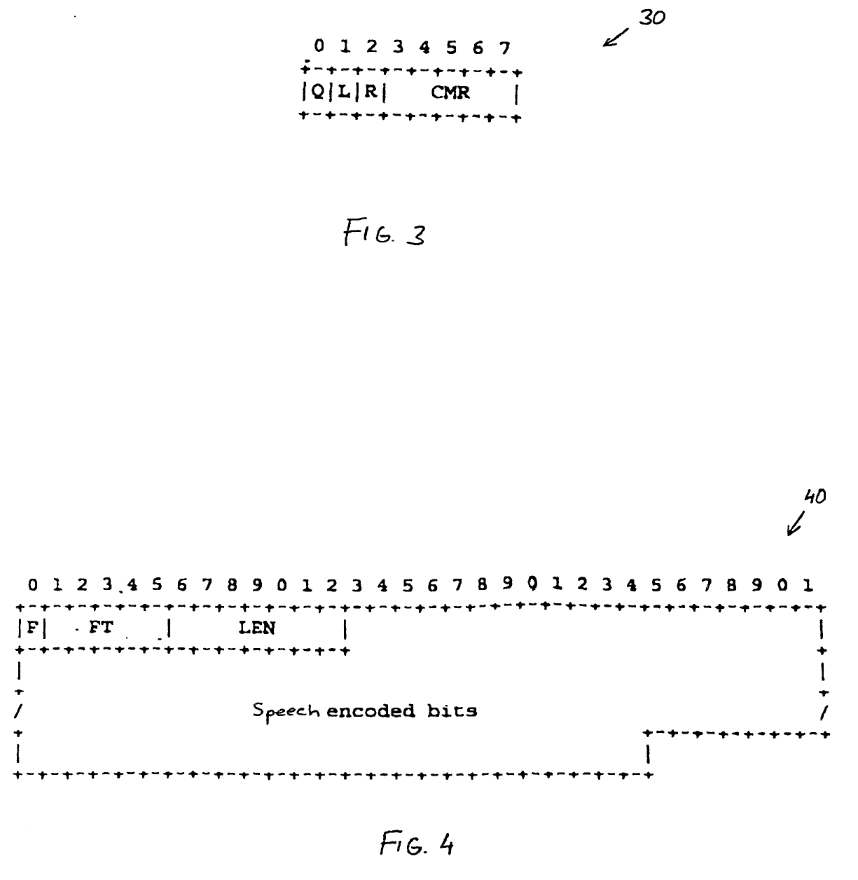

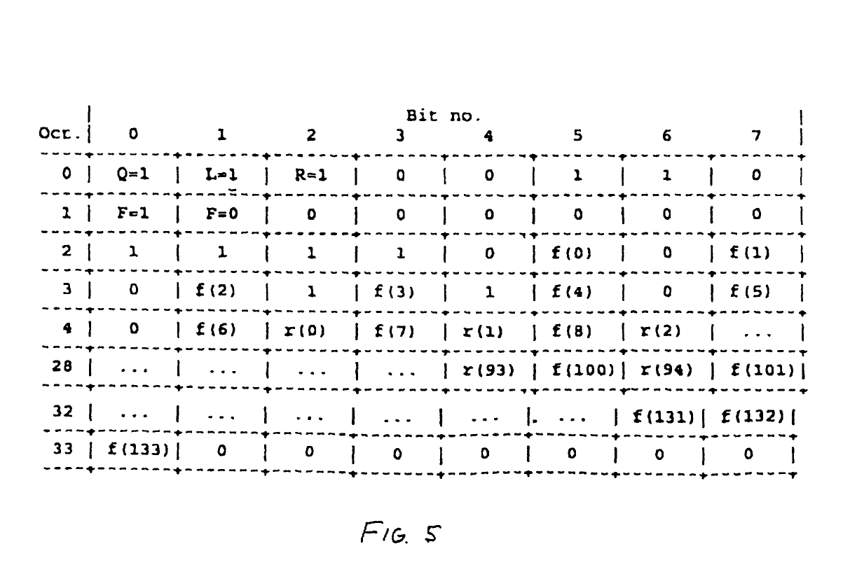

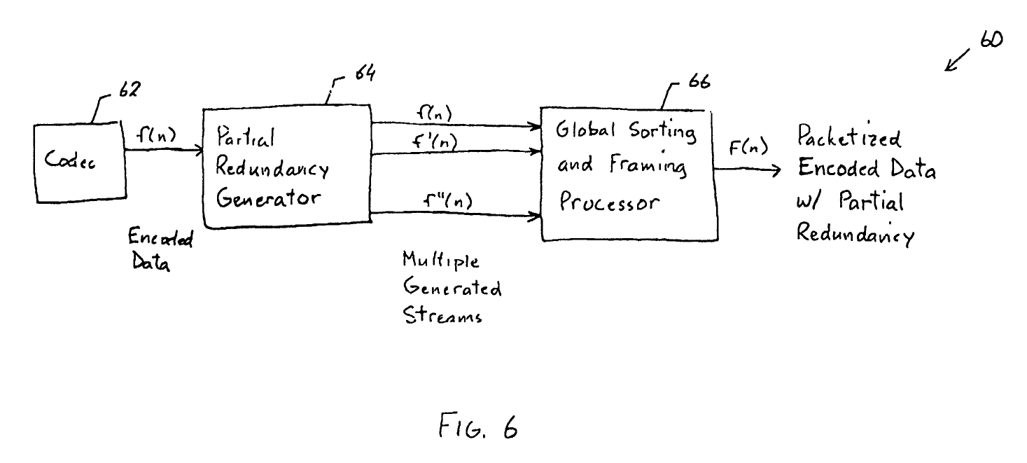

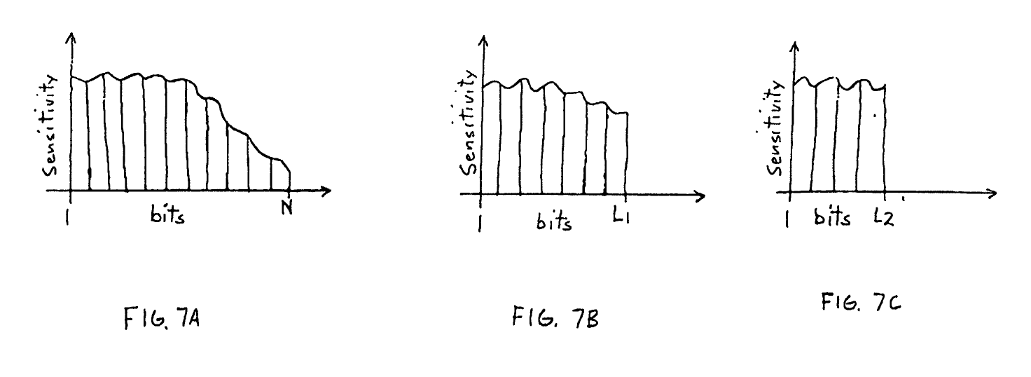

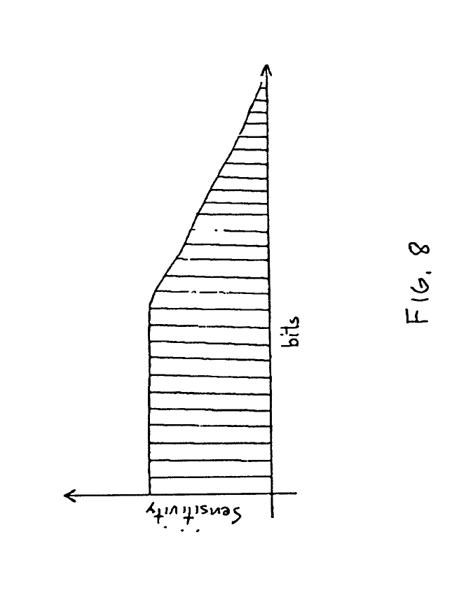

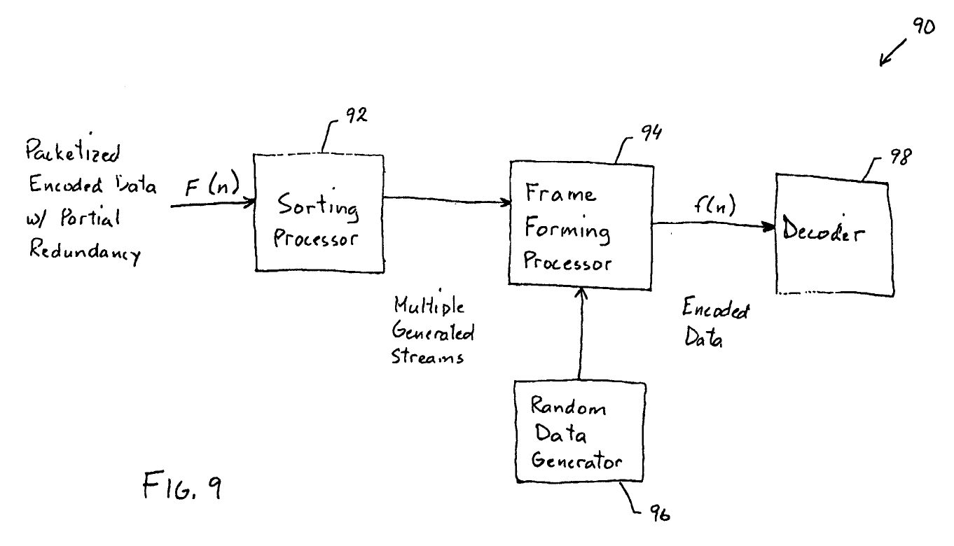

As an example, FIG. 4 illustrates the format of the AMR payload frame 40 of the present invention, with every AMR payload frame representing one encoded speech frame. The payload frame 40 includes several specified fields as follows:

F (1 bit): Indicates if this frame is the last in the payload or if further frames follow. If F=1, further frames follow; if F=0, this is the last frame.

FT (5 bits): Indicates the frame type indicating the speech coding mode.

LEN (7 bits): This is an optional field which exists only if the payload header bit L is set (L−1). LEN specifies the number of octets of the encoded bits in this frame. If LEN indicates fewer bits than given by the FT indicated mode, then LEN gives the valid number of encoded bits. For example, if a frame is transmitted only partially (with the least sensitive bits at the end of the frame being omitted), then the LEN value would be used as the valid number of bits for this frame. (Thus, the LEN field may be used for transmission of partial redundant data.)

Speech encoded bits: This is the speech codec encoded data field. The length of this field is defined by the LEN field. The last payload frame will always contain a full frame, i.e., no LEN field is needed.

To maintain sensitivity ordering when more than one speech frame is transmitted in one payload, the payload frames are sorted by interleaving one bit from each payload, as illustrated in FIG. 5. Alternatively, the interleaving may be performed on groups or blocks of bits. In this example, two frames were sent. L=1 indicates the existence of the LEN field in the payload frames. At the start of the payload frames, F=1 means that there is at least one more frame following this frame, and F=0 means the second frame is the last one. The next 10 bits are the FT bits (5 each frame) alternating between the first and second frames.

Because the second frame is being used as a redundant frame in this exemplary embodiment, only part of that frame (12 octets) is sent. Hence, the next 13 bits after the 10 FT bits are alternately the LEN bits of the second frame (recall L=1) and the encoded/sorted data bits of the first frame. In this example, LEN=12. After the LEN bits, the remainder of the payload is filled in with data bits, f(0)- f(133) for the first frame and r(0)-r(95) for the redundant frame. Zeroes are inserted into any unfilled bits.

As mentioned previously, the codec sorts the encoded bits in order of descending sensitivity within a frame. The sorting algorithm can be described in C-code as follows:

for (i = 0; i < H; i++) {

b(i) = h(i);

}
max = max(F(0), . . . ,F(N−1) );
k = H;
for (i = 0; i < max; i++) {

for (j = 0; j < N; j++) {

if (i < F(j) ) {

b(k++) = f(j,i);

}

}

}
S = 8 − k%8;
if (S < 8) {

for (i = 0; i < S; i++) {

b(k++) = 0;

}

}

where:

b(m) is the bit m of RTP final payload;

f(n,m) is the bit m in payload frame n;

F(n) is the number of bits in payload frame n, defined by FT or by LEN;

h(m) is the bit m of the payload header;

H is the number of payload header bits, 3 or 8 bits;

N is the number of payload frames in the payload; and

S is the number of unused bits.

For reference purposes, the payload frames f(n,m) are ordered in consecutive order, with frame n=1 preceding frame n=2.

FIG. 6 is a functional block diagram illustrating the general flow and functional components of a transmitter 60 according to one embodiment of the present invention. Encoded data f(n) from a codec 62 is received by a partial redundancy generator 64. The codec 62 is preferably an AMR codec. The redundancy generator 64 takes the sorted encoded data f(n) and generates one or more streams of partial redundant data f′ (n)and f″ (n) based on the current sorted encoded data f(n). The partial redundancy generator 64 then provides the partial redundant data f′ (n) and f″ (n), along with the current encoded speech data f(n), to a global sorting and framing processor 66. The global sorting and framing processor 66 receives the multiple streams of data and performs a global sorting and framing process on the data. In one exemplary embodiment, the global sorting and framing processor 66 must store in a buffer at time(n), the bits of the current sorted encoded speech data f(n) with the previous partial redundant data f′ (n−1) and f″ (n−2). However, the current partial redundant data f′ (n) and f″ (n) are reserved for future sets of encoded speech data. The result is a stream of packets F(n), each packet having a full frame of the current encoded speech data f(n) and one or more partial frames containing copies of previously transmitted encoded speech data f′ (n−1) and f″ (n−2). The packetized encoded data with partial redundant frames are then sent to a packet transmission network (not shown) for transmission to a receiver.

FIG. 7A is a chart illustrating the sensitivity levels of an exemplary packet containing a frame with N bits of sorted and encoded speech data. The vertical axis represents sensitivity and the horizontal axis represents the number of bits. As can be seen, the N bits in this exemplary packet are arranged in order of descending sensitivity with the most sensitive bits arranged first and the least sensitive bits arranged last. The charts in FIGS. 7B-7C illustrate the sensitivity levels of packets containing partial frames produced by the partial redundancy generator 64. Note that only the first L1 and L2 bits considered to be most sensitive in their respective frames were selected for transmission. The specific number of bits L1 and L2 selected varies and may depend on a number of factors including the level of robustness required by the system, the characteristics of the transmission link, and the allowed overhead for redundant data. Under such an arrangement, the amount of any additional bandwidth required for redundant transmission is limited only to bits that are considered to be highly sensitive.

FIG. 8 illustrates the sensitivity levels of the packetized encoded data with partial redundancy produced by the global sorting and framed processors 66. The packet in FIG. 8 includes a frame of current data interleaved with one or more partial frames of redundant previous data. As can be seen, the most sensitive bits, including those in the partial redundant frames, are grouped together at the front while the least sensitive bits are at the back.

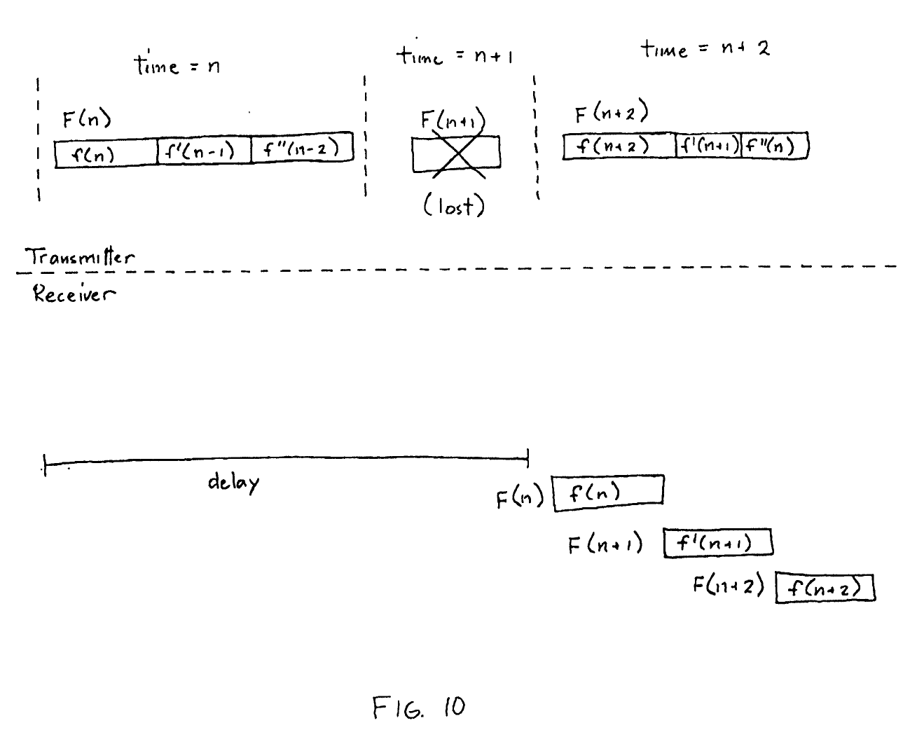

FIG. 9 illustrates the general flow and functional components of the receiver 90 according to an exemplary embodiment of the present invention. A sorting processor 92 receives a packet having current encoded speech data and previous partial redundancy from the transmitter 60. The sorting processor 92 sorts the frames of current encoded speech data and previous partial redundant data to generate multiple streams of packets including a packet with a frame of the current encoded speech data and one or more packets having frames of previous partial redundant data. A frame forming processor 94 reconstructs any packets which were lost during transmission by using the partial redundant data. If any of the bits cannot be reconstructed from the partial redundant data (e.g., because they were not transmitted), these bits may be substituted with randomly generated data. This can be achieved in several ways and an example would be through the random data generator 96. Of course, if the damage were severe, one of the several mechanisms available could be implemented to overcome the problem. Although the term “severe” is a somewhat relative term, those of ordinary skill in the art may readily define the acceptable level of damage as needed for the particular application. The reconstructed packet containing the frame of encoded data is then sent to a decoder 98 for conversion into ordinary speech.

FIG. 10 illustrates the frame forming process in more detail. A broken line represents the separation between the transmitter and receiver side. On the transmitter side, a packet F(n), including current data frame f(n) and partial redundant data frames of previously sent data f′ (n−1) and f″ (n−2), is sent at time=n. The packet at time=n+1, however, was severely damaged or otherwise lost during transmission. Another packet F(n+2) similar to the packet F(n) is sent at time=n+2.

On the receiver side, after a certain predefined delay, the packets F(n) and F(n+2) are sorted and processed. Although the packet F(n+1) was damaged during transmission, it may be reconstructed by using the partial redundant data frame f′ (n+1) contained in the packet F(n+2). If any of the bits of the damaged packet F(n+1) cannot be reconstructed, they may be substituted with randomly generated data. As noted previously, however, if the packet F(n+1) were severely damaged, one of the several mechanisms available could be used to tackle the issue.

The foregoing description is of a preferred embodiment for implementing the invention, and the scope of the invention should not necessarily be limited by this description. The scope of the present invention is instead defined by the following claims.

What is claimed is:

1. A method of transmitting encoded speech data in a telecommunications network, said encoded speech data being divided into a plurality of respective encoded speech frames, the method comprising:
sorting at least one of said plurality of speech frames having respective encoded speech data therein, said respective encoded speech data having a predetermined error sensitivity characteristic associated therewith;
generating partial redundant data corresponding to said sorted encoded speech data within said at least one speech frame; and
transmitting a data packet containing said sorted encoded speech data and said partial redundant data.

2. The method according to claim 1, further comprising the step of:
reconstructing, after said step of transmitting, the transmitted data packet using said partial redundant data.

3. The method according to claim 2, further comprising the step of:
adding data to said reconstructed data packet.

4. The method according to claim 1, wherein said partial redundant data includes previously transmitted sorted encoded speech data.

5. The method according to claim 1, wherein said sorted encoded speech data and the partial redundant data corresponding thereto within said at least one speech frame are sorted on a single-bit basis.

6. The method according to claim 1, wherein said sorted encoded speech data and the partial redundant data corresponding thereto within said at least one speech frame are sorted on a multiple-bit basis.

7. The method according to claim 1, wherein said partial redundant data is sorted according to a second predetermined error sensitivity characteristic.

8. A system for communicating encoded speech data in a telecommunications network, said encoded speech data being divided into a plurality of respective speech frames, the system comprising:
a codec for sorting at least one of said plurality of speech frames having respective encoded speech data therein, said speech data having a predetermined error sensitivity characteristic associated therewith;
a partial redundancy generator for generating partial redundant data corresponding to said sorted encoded speech data within said at least one speech frame; and
a transmitter for transmitting a data packet containing said sorted encoded speech data and said partial redundant data.

9. The system according to claim 8, further comprising a sorting processor for reconstructing said transmitted data packet, after said transmitter transmits said transmitted data packet, using said partial redundant data.

10. The system according to claim 8, wherein said partial redundant data includes previously transmitted sorted encoded speech data.

11. The system according to claim 8, wherein said encoded speech data and the partial redundant data corresponding thereto within said at least one speech frame are sorted on a single-bit basis.

12. The system according to claim 8, wherein said encoded speech data and the partial redundant data corresponding thereto within said at least one speech frame are sorted on a multiple-bit basis.

13. The system according to claim 8, wherein said partial redundant data is also sorted according to a second predetermined error sensitivity characteristic.

14. A codec for sorting data over a communications link, said codec comprising:
sorting means for sorting at least one of a plurality of speech frames having encoded speech data therein, said respective encoded speech data having a predetermined error sensitivity characteristic associated therewith; and
generating means for generating partial redundant data corresponding to said sorted encoded speech data within said at least one speech frame.

15. The codec according to claim 14, further comprising:
transmitting means for transmitting a data packet containing the sorted encoded speech data and the partial redundant data corresponding thereto within said at least one speech frame.

16. The codec according to claim 14, further comprising a sorting processor for reconstructing said transmitted data packet using said partial redundant data.

17. The codec according to claim 14, wherein said partial redundant data includes previously transmitted sorted encoded speech data.

18. The codec according to claim 14, wherein said encoded speech data and the partial redundant data corresponding thereto within said at least one speech frame are sorted on a single-bit basis.

19. The codec according to claim 14, wherein said encoded speech data and the partial redundant data corresponding thereto within said at least one speech frame are sorted on a multiple-bit basis.

20. The codec according to claim 14, wherein said partial redundant data is sorted according to a second predetermined error sensitivity characteristic.
